(19) United States
(12) Patent Application Publication
(10) Pub. No.: US 2025/0054217 A1
(43) Pub. Date: Feb. 13, 2025

(54) SYSTEMS AND METHODS FOR COMMENTING ON DIGITAL MEDIA CONTENT WITH LIVE AVATARS

(71) Applicant: Meta Platforms Technologies, LLC, Menlo Park, CA (US)

(72) Inventors: David Glauber, White Plains, NY (US); Erika Lee, Cupertino, CA (US)

(21) Appl. No.: 18/447,952

(22) Filed: Aug. 10, 2023

(51) Int. Cl. G06T 13/40; G06Q 50/00; G06V 40/20

(52) U.S. Cl. CPC G06T 13/40; G06Q 50/01; G06V 40/20

(57) ABSTRACT

The disclosed computer-implemented systems and methods may map a user's expressive gestures onto the user's avatar and position the mirrored avatar onto a digital media feed thereby enabling the user to comment on and react to the digital media feed in real-time via their avatar. For example, the disclosed systems and methods can position the user's mirrored avatar onto digital media feeds include live camera streams, digital videos, and digital images. The disclosed systems and methods can position the user's mirrored avatar onto digital media feeds including digital media items from the user's client computing device. Additionally, the disclosed systems and methods can position the user's mirrored avatar onto digital media feeds including digital media items associated with other users within a social networking system. Various other methods, systems, and computer-readable media are also disclosed.

### BRIEF DESCRIPTION OF THE DRAWINGS

The accompanying drawings show exemplary implementations and are part of the specification. Together with the following description, these drawings demonstrate and explain various principles of the present disclosure.

FIG. 1 is an overview diagram of an environment in which an avatar commentary system operates in accordance with one or more implementations.

FIG. 2 is a flow diagram of an exemplary computer-implemented method for generating a digital media feed overlaid with an avatar that mirrors a user's expressive gestures in real-time in accordance with one or more implementations.

FIGS. 3A-6B illustrate the avatar commentary system generating combination digital media feeds in accordance with one or more implementations.

FIG. 7 is a detailed diagram of the avatar commentary system in accordance with one or more implementations.

Throughout the drawings, identical reference characters and descriptions indicate similar, but not necessarily identical, elements. While the exemplary implementations described herein are susceptible to various modifications and alternative forms, specific implementations have been shown by way of example in the drawings and will be described in detail herein. However, the exemplary implementations described herein are not intended to be limited to the particular forms disclosed. Rather, the present disclosure covers all modifications, equivalents, and alternatives falling within the scope of the appended claims.

### DETAILED DESCRIPTION OF EXEMPLARY IMPLEMENTATIONS

Social networking systems provide many ways for users to engage with each other. For example, some social networking systems enable users to post videos, images, and live streams. Some social networking systems further enable users to view content posted by co-users (e.g., their “friends”). In some cases, social networking systems can enable users to interact with co-users' content by sharing the content, commenting on the content, “liking” the content, and so forth.

Interactions via these techniques, however, are often easily missed. For example, a social networking system may enable a user to comment on another user's posted digital video. Despite this, the digital video creator and other social networking system users may have to click into a separate display and scroll through other comments to read the newly added comment. Similarly, a social networking system may enable a user to “like” another user's video stream (e.g., real-time, recorded, uploaded, or otherwise asynchronous). The social networking system, however, may only indicate the new “like” by incrementing a number or displaying an emoticon for a few seconds. As such, existing interaction techniques are limited to a few predefined reactions that often fail to clearly indicate the user who submitted them.

These limitations become even more pronounced when the digital content being reacted to is popular. For example, a popular posted digital video may garner thousands of reactions (e.g., likes, hearts, thumbs ups, surprised faces) shares, and comments. Despite this, it is unlikely that anyone would spend the time needed to read all the comments and/or determine who submitted any of the thousands of reactions.

In some cases, users may attempt to react to or comment on social networking system content in other ways. For example, a user may film themselves reacting to another user's posted digital video (e.g., via a front-facing camera of a smart phone or tablet). The user may then use third-party software to stitch the self-reaction video to the other user's posted digital video. While this way of reacting is more personalized and expressive, it often necessitates a separate software application (e.g., beyond a social networking system application) in addition to the time and resources spent in editing the two videos together.

To remedy these problems, the present disclosure describes implementations that combine a live feed of a user's avatar with other social media content for broadcast within a social networking system. As will be described in greater detail below, these implementations can map a user's expressive gestures onto the user's avatar. The implementations described herein can further position the user's avatar over an area of a digital media feed and broadcast the digital media feed with the avatar to other social networking system users. In this way, the implementations described herein enable social networking system users to comment on each other's digital media in a way that is fast, engaging, efficient, and maintains a level of user anonymity. Moreover, the implementations described herein also make it easier for a user to discern between original media and user commentary.

Features from any of the implementations described herein may be used in combination with one another in accordance with the general principles described herein. These and other implementations, features, and advantages will be more fully understood upon reading the following detailed description in conjunction with the accompanying drawings and claims.

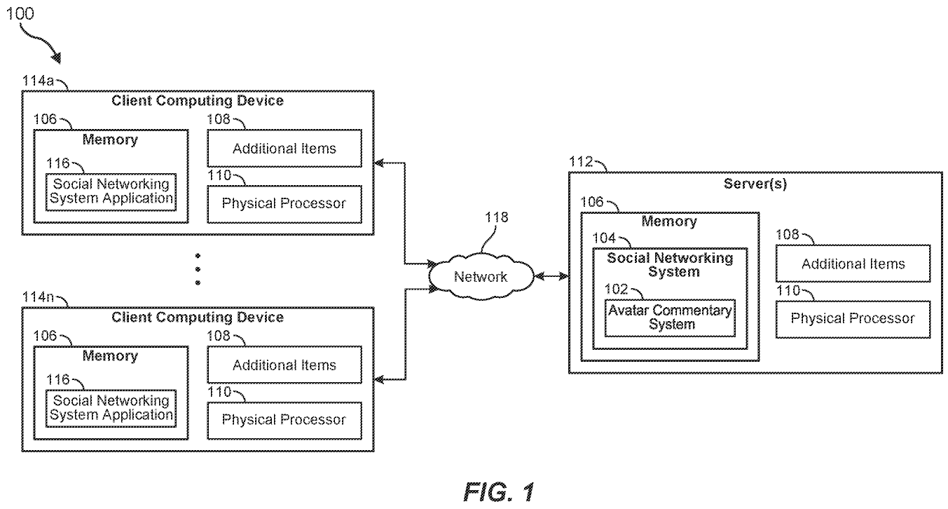

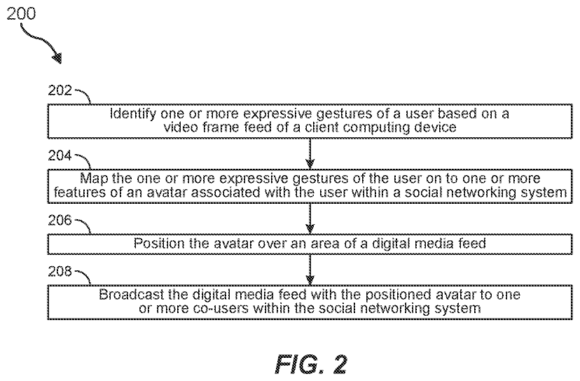

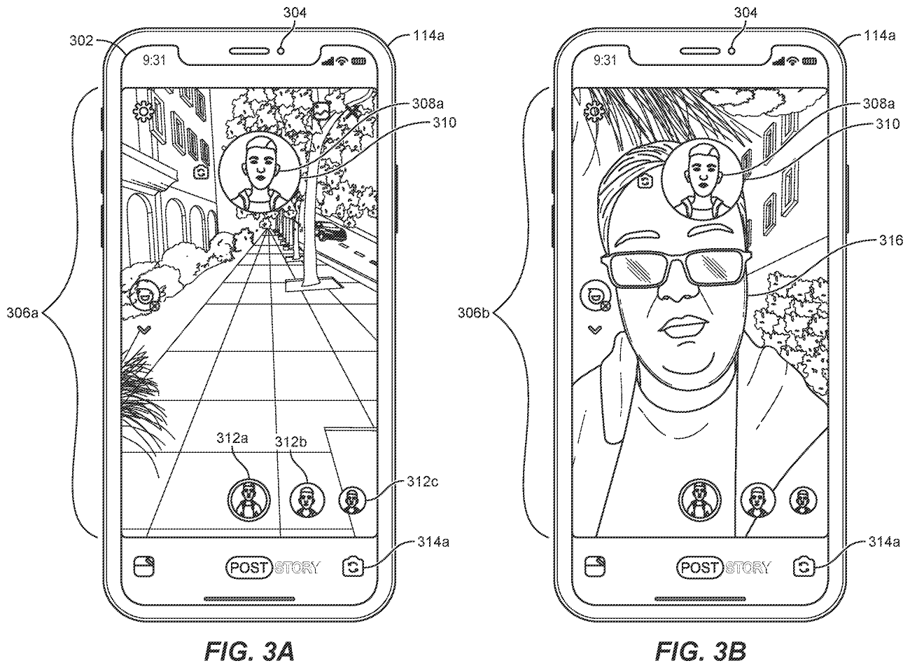

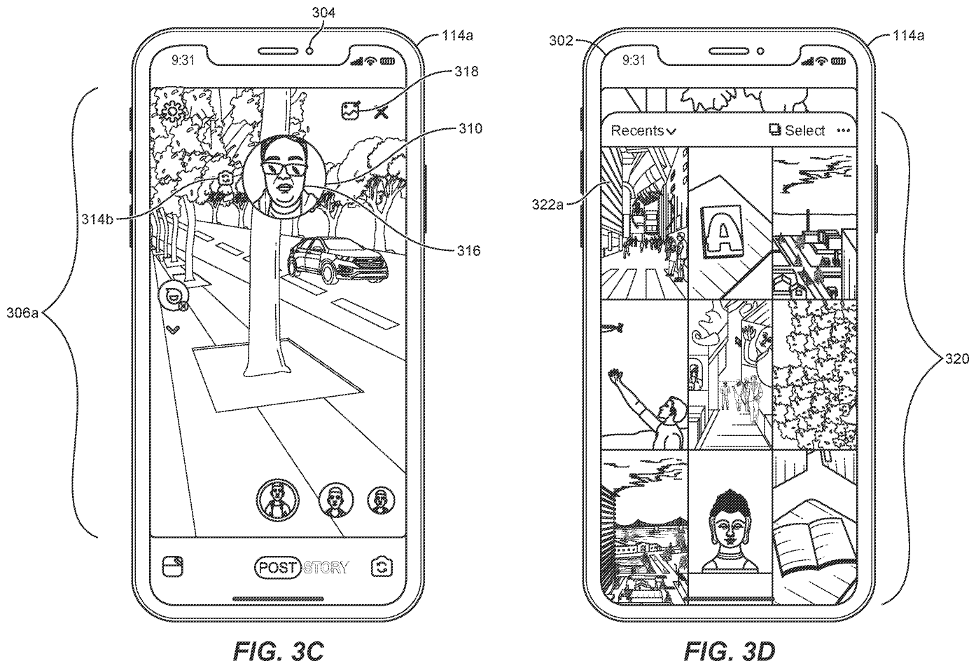

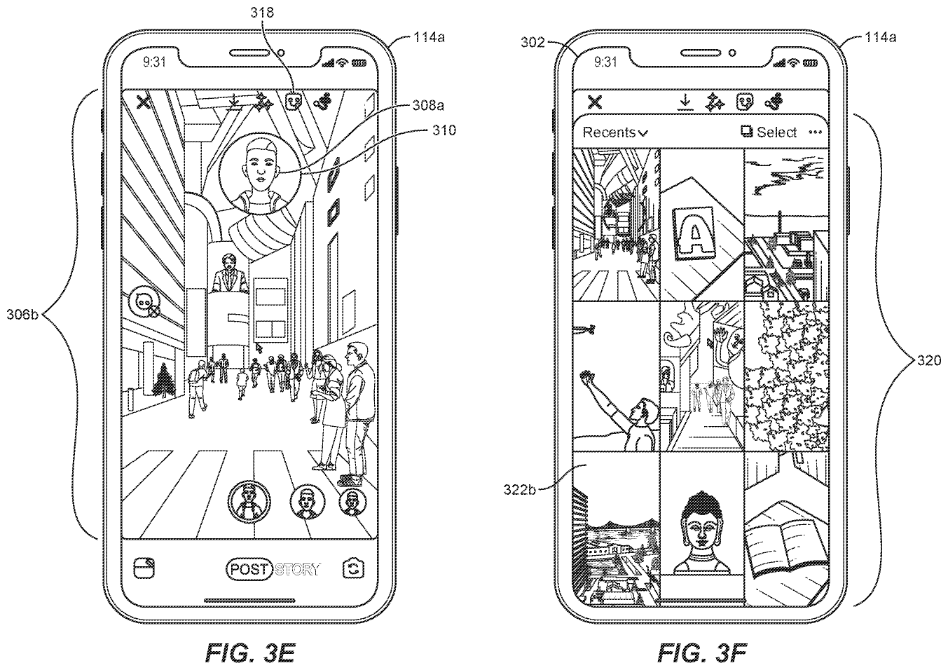

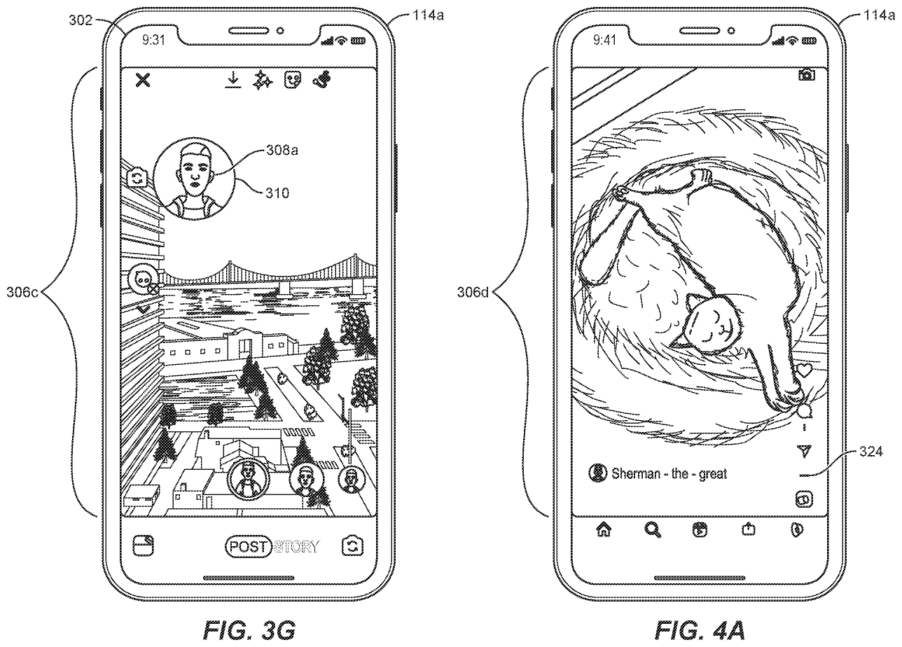

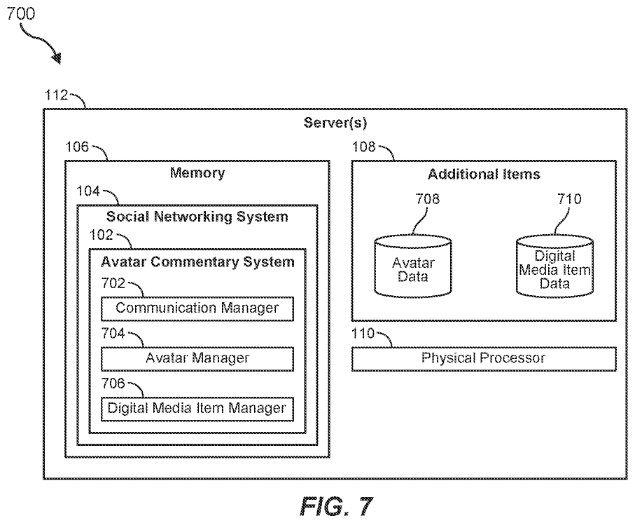

The following will provide, with reference to FIGS. 1-7, detailed descriptions of an avatar commentary system that combines avatar-based live streams with digital media feeds, thereby enabling a user to comment on a digital media feed in a way that is quick and engaging. For example, FIG. 1 shows a networked environment where the avatar commentary system interacts with a social networking system and other client computing devices to generate a display of an avatar mapped to expressive gestures of one user and broadcast the generated display positioned over a digital media feed to other users within the social networking system. FIG. 2 shows a flow diagram of steps taken by the avatar commentary system while performing these acts. FIGS. 3A-6B illustrate user interfaces and components generated and displayed by the avatar commentary system during the process of positioning a user's mapped avatar over a digital media feed. Finally, FIG. 7 shows a detailed diagram illustrating additional features and functionality of the avatar commentary system.

As just mentioned, FIG. 1 illustrates an exemplary networking environment 100 implementing aspects of the present disclosure. For example, the networking environment 100 can include server(s) 112, client computing devices 114a-114n and a network 118. As further shown, the server(s) 112 and the client computing devices 114a-114n can each include a memory 106, additional elements 108, and a physical processor 110.

In at least one implementation, an avatar commentary system 102 can be implemented as part of a social networking system 104, within the memory 106 of the server(s) 112. In some implementations, each of the client computing devices 114a-114n may also include a social networking system application 116 installed on the memories 106 thereon. As shown in FIG. 1, the client computing devices 114a-114n and the server(s) 112 can communicate via the network 118 to transmit and receive social networking system data.

As illustrated in FIG. 1, the client computing devices 114a-114n can include any type of user device suitable for social networking system activity including, but not limited to, smart phones, smart wearables, laptop computers, desktop computers, tablet computers, video conferencing devices, and virtual reality devices. In at least one implementation, the user of the client computing device 114a may be a digital media feed commenter. Additionally, the users of the remaining client computing devices may be digital media feed posters (e.g., users who post digital media items within the social networking system 104) and/or co-users of the user of the client computing device 114a who may have permission or access to digital media items posted by the user of the client computing device 114a and broadcast by the avatar commentary system 102 within the social networking system 104.

As mentioned above, the avatar commentary system 102 can operate as part of the social networking system 104. In one or more implementations, the social networking system 104 can provide various features to social networking system users. For example, the social networking system 104 can provide features enabling users to post and view content via multiple channels (e.g., newsfeed posts, short-form videos, live broadcasts). In one or more implementations, the social networking system 104 can also maintain connections between social networking system users such that users can view and interact with content generated by other social networking system users.

Moreover, as shown in FIG. 1, the client computing devices 114a-114n can include the social networking system application 116. In one or more implementations, the social networking system application 116 can transmit and receive data to and from the social networking system 104. In at least one implementation, the social networking system application 116 can detect and transmit social networking system activity information. For example, in some implementations, the social networking system application 116 can transmit detected user interaction information. Moreover, in some implementations, the social networking system application 116 can transmit a video frame feed from a front-facing or rear-facing camera of the client computing device 114a to enable the avatar commentary system 102 to map the expressive gestures of the user of the client computing device 114a to the user's avatar. Moreover, in some implementations, the social networking system application 116 can also transmit other types of camera and sensor information generated by components of an AR/VR client computing device.

As mentioned above, the client computing devices 114a-114n and the server(s) 112 may be communicatively coupled through the network 118. The network 118 may represent any type or form of communication network, such as the Internet, and may include one or more physical connections, such as a LAN, and/or wireless connections, such as a WAN.

Although FIG. 1 illustrates components of the network environment 100 in one arrangement, other arrangements are possible. For example, in one implementation, the avatar commentary system 102 and the social networking system 104 may exist across multiple networked servers. In another implementation, the avatar commentary system 102 may operate as a web browser plugin and/or an extension to the social networking system application 116. In some implementations, features of the avatar commentary system 102 may be incorporated into the social networking system application 116, while other features reside within the social networking system 104 on the server(s) 112. In additional implementations, the networking environment 100 may include any number of client computing devices and/or servers.

In one or more implementations, the methods and steps performed by the avatar commentary system 102 reference multiple terms. For example, as used herein, the term “expressive gesture” can refer to a user movement. The user movement may be in any area or combination of areas within the user's body. As such, an expressive gesture can include facial movements or gestures, head movements or gestures, limb movements or gestures, and/or whole-body movements or gestures. To illustrate, the user may perform expressive gestures including, but not limited to, talking, smiling, frowning, laughing, moving eyebrows, nodding their head, moving their hands and arms, jumping up and down, dancing, etc.

As used herein, the term “video frame feed” can refer to a stream of image frames captured by a camera of a client computing device. For example, the camera of the client computing device may capture digital images at a specified frame rate. The client computing device can further send the captured digital images in sequence to the avatar commentary system 102 as the video frame feed. In some implementations, the avatar commentary system 102 may store tracked movement data (e.g., from a video frame feed) into a data object and utilize the data object to animate an avatar. As used herein, the term “representative frame” can refer to a captured digital image from the video frame feed from which the avatar commentary system 102 can determine the user's depicted expressive gesture in order to map the gesture onto the user's avatar. The video frame feed can include many representative frames. As such, representative frames may be every frame from the video frame feed, every other frame from the video frame feed, every fifth frame from the video frame feed, and so forth.

As used herein, the term “gesture landmarks” can refer to points within a representative frame that are associated with an expressive gesture being made by the user depicted in the representative frame. As such, gesture landmarks can include facial landmarks, joint landmarks, limb landmarks, hair landmarks, body-shape landmarks, body landmarks, and so forth. In one or more implementations, a landmark may be a center point of a body part (e.g., the center point of an eye, the center point of a mouth). In additional implementations, a landmark may be a point along the outline of a body part (e.g., an outline point of the user's hair). As such, a body part that is included in an expressive gesture may be associated with multiple landmarks. Each landmark can be associated with “relative coordinates.” As used herein, “relative coordinates” can refer to pixel coordinates of a landmark point relative to the outer edges of the representative frame. For example, the relative coordinate of a landmark point may be x and y coordinates of the point relative to a bottom, left-hand corner of the representative frame.

As used herein, an “avatar” can refer to a digital representation of a user. For example, the user can configure an avatar to be a digital approximation of themselves. Alternatively, the user can configure the avatar to look like any other figure (e.g., an animal, a video game character, an alien, etc.). In one or more implementations, an avatar can include avatar landmarks that—much like the user landmarks described above—can be points associated with body parts of the avatar. In some implementations, an avatar's landmarks can be represented as coordinates within metadata associated with the avatar.

As used herein, a “digital media feed” can refer to a display of a digital media item. For example, a digital media feed can include a static display of a digital image. In additional implementations, a digital media feed can include playback of a digital video or can display a camera frame feed in real-time. As used herein, a “digital media item” can refer to a digital image or digital video (e.g., long-form video or short-form video) stored on a client computing device or on the social networking system 104. Additionally, a digital media item can refer to a feed or stream originating from a client computing device. As used herein, a “rear-facing camera video frame feed” can refer to a camera video frame feed originating from a rear-facing camera (e.g., facing away from the user) of the client computing device.

As further used herein, a “digital image camera roll” can refer to a collection of thumbnails representing digital media items. The digital media items represented in the digital image camera roll can be stored locally on a client computing device or may be stored in the cloud by the social networking system 104 or other third-party. A camera roll may be organized chronologically such that newest digital media items are shown first. As used herein, a “short-form video” may refer to a digital video that has a runtime less than a predetermined length. A “long-form video” may refer to a digital video that has a runtime that corresponds with a TV episode or movie.

As used herein, a “pre-generated animation” can refer to a set of instructions for adjusting landmarks of an avatar in a sequence. For example, a pre-generated animation can be applied to an avatar to make the avatar appear like it is dancing, jumping, doing somersaults, etc. In some implementations, the pre-generated animation can include additional instructions to repeat the sequence of movements a certain number of times, for a certain amount of time, or indefinitely.

As used herein, a “social networking system platform” can refer to a particular social networking system outlet associated with the social networking system 104. For example, the social networking system 104 may be associated with a platform that includes user newsfeeds. The social networking system 104 may be associated with another platform that includes short-form videos posted by users, and so forth. As used herein, a “notification” can be a pop-up, a banner, an email, an SMS message, or any other type of digital notification.

As mentioned above, FIG. 2 is a flow diagram of an exemplary computer implemented method 200 for combining avatar-based live streams with digital media feeds in order to provide commentary on the digital media feeds. The steps shown in FIG. 2 may be performed by any suitable computer-executable code and/or computing system, including the system(s) illustrated in FIG. 7. In one example, each of the steps shown in FIG. 2 may represent an algorithm whose structure includes and/or is represented by multiple sub-steps, examples of which will be provided in greater detail below.

As illustrated in FIG. 2, at step 202 the avatar commentary system 102 can identify one or more expressive gestures of a user based on a digital media feed of a client computing device. For example, the avatar commentary system 102 can extract one or more video frames from a video feed of the client computing device 114a. The avatar commentary system 102 can further analyze the one or more video frames to determine one or more gesture landmarks of a user's face, joints, limbs, hair, and body. The avatar commentary system 102 can further determine coordinates for each of the one or more gesture landmarks relative to the borders of the video frame.

Additionally, at step 204 the avatar commentary system 102 can map the one or more expressive gestures of the user onto one or more features of an avatar associated with the user within a social networking system. For example, the avatar commentary system 102 can identify the user's avatar within the social networking system 104 and determine one or more avatar landmarks that correspond to the gesture landmarks of the user from the one or more video frames. The avatar commentary system 102 can further map the user's expressive gestures onto the avatar by adjusting positions of the one or more avatar landmarks based on the relative coordinates of the user's gesture landmarks.

As further illustrated in FIG. 2, at step 206 the avatar commentary system 102 can position the avatar over an area of a digital media feed. For example, the avatar commentary system 102 can position the avatar over the digital media feed within a bubble, in the foreground of the digital media feed, farther back into the digital media feed view as a full-bodied avatar, and so forth. In some implementations, the avatar commentary system 102 can position the avatar in accordance with a user selection of a particular area within the digital media feed. In one or more implementations, the avatar commentary system 102 can position the avatar over a digital media feed originating at the client computing device 114a (e.g., a video feed from a rear-facing camera of the avatar commentary system 102), a digital media feed recorded by a different user of the social networking system 104 and posted to the social networking system 104 (e.g., a short-form video recorded and posted by another user of the social networking system 104), and/or a digital media feed of a digital image from a camera roll on the client computing device 114a and/or a camera roll associated with a social networking system account of the user of the client computing device 114a.

Furthermore, at step 208 the avatar commentary system 102 can broadcast the digital media feed with the positioned avatar to one or more co-users within the social networking system. For example, the avatar commentary system 102 can broadcast the digital media feed with the positioned avatar as a short-form video, as a live feed, as a newsfeed post, and so forth. The avatar commentary system 102 can determine recipients of the broadcasted digital media feed based on a social network that indicates co-users (e.g., “friends”) of the broadcasting user, groups associated with the broadcasting user, followers of the broadcasting user, and so forth. In this way, the avatar commentary system 102 enables the use of avatars in commenting on media. Additionally, the avatar commentary system 102 can use the same steps described above to enable the use of an avatar in re-commenting on media that was previously commented on (e.g., by the same or by a different user).

As discussed above, the avatar commentary system 102 can combine a live feed of a user's avatar mapped to the user's real-time expressive gestures with a digital media feed. In one or more implementations, the avatar commentary system 102 enables users to comment in real-time on their own or other users' digital media feeds within the social networking system 104 in a way that requires no third-party software applications. FIGS. 3A-6B illustrate how the avatar commentary system 102 maps avatar features to a user's expressive gestures in real-time and then combines the user's avatar with a digital media feed including a camera feed from the user's client computing device, digital photographs on the user's client computing device or associated with the user's social networking system account, and/or with other user's digital media content within the social networking system 104.

For example, as shown in FIG. 3A, the avatar commentary system 102 can map the expressive gestures of a user of the client computing device 114a onto features of an avatar 308a. The avatar commentary system 102 can further position the avatar 308a over a digital media feed 306a within a display 302 on the client computing device 114a. In more detail, the avatar commentary system 102 can access a video frame feed from a front-facing camera 304 of the client computing device 114a. In most implementations, the video frame feed of the front-facing camera 304 can include video frames depicting at least a face of the user of the client computing device 114a. Accordingly, and as will be described in greater detail below with regard to FIG. 7, the avatar commentary system 102 can identify representative frames from the video frame feed, determine gesture landmarks in the representative frames, and identify relative coordinates for each of the gesture landmarks. The avatar commentary system 102 can then map the user's expressive gestures onto the avatar 308a by adjusting positions of the features (e.g., facial features, body features) of the avatar 308a based on the relative coordinates of the user's gesture landmarks. By performing these steps in connection with relative frames (e.g., every fifth frame, every tenth frame) from the video frame feed, the avatar commentary system 102 can adjust positions of the features of the avatar 308a such that the avatar 308a appears to mirror the user of the client computing device 114a in real-time.

As further shown in FIG. 3A, the avatar commentary system 102 can position the avatar 308a over an area of the digital media feed 306a. For example, in at least one implementation, the avatar commentary system 102 can arrange the avatar 308a within a bubble 310. The avatar commentary system 102 can then place the bubble 310 containing the avatar 308a over the digital media feed 306a. As will be shown in greater detail below, the avatar commentary system 102 can position the avatar 308a in other ways over the digital media feed 306a. In some implementations, the avatar commentary system 102 may automatically position the avatar 308a in a default position (e.g., a middle-top portion of the digital media feed 306a). In additional implementations, the avatar commentary system 102 may utilize computer vision techniques to identify an area of the digital media feed 306a where there are little/few objects and/or movement and automatically position the avatar 308a in a position over that area.

In one or more implementations, the digital media feed 306a can include various types of media. For example, as shown in FIG. 3A, the digital media feed 306a can include a video frame feed from a rear-facing camera of the client computing device 114a. As such, the digital media feed 306a can include a view of an area in front of the user of the client computing device 114a—provided that the user of the client computing device 114a is holding the client computing device 114a up in front of themselves.

In some implementations, the avatar commentary system 102 can change the size and/or orientation of the avatar 308a within the bubble 310. For example, in response to a detected selection of one of the avatar options 312a, 312b, or 312c, the avatar commentary system 102 can change the size of the avatar 308a and the bubble 310 positioned over the digital media feed 306a. To illustrate, in response to a detected selection of the avatar option 312a, the avatar commentary system 102 can generate the avatar 308a within the bubble 310 at a larger size with the avatar 308a being shown from the waist up. In response to a detected selection of the avatar option 312b, the avatar commentary system 102 can generate the avatar 308a within the bubble 310 at a larger size being shown from the shoulders up. In response to a detected selection of the avatar option 312c, the avatar commentary system 102 can generate the avatar 308a within the bubble 310 at a smaller size being shown from the shoulders up. While the bubble 310 is shown in a circular configuration, other configurations are possible. For example, in other implementations, the bubble 310 may be a different shape, may include a different border, may be outlined in a different color, and so forth.

Moreover, in one or more implementations, the avatar commentary system 102 can change the digital media feed 306a to different camera views. For example, as shown in FIG. 3B and in response to a detected selection of a swap button 314a, the avatar commentary system 102 can change the digital media feed 306a to display the video frame feed from the front-facing camera 304 of the client computing device 114a. As such, the avatar commentary system 102 can position the user's avatar 308a over a digital media feed of the user of the client computing device 114a in real-time.

In one or more implementations, the avatar commentary system 102 can also change the display shown in the bubble 310. For example, as shown in FIG. 3C and in response to a detected selection of a swap button 314b, the avatar commentary system 102 can exchange the user's avatar 308a with a video frame feed 316 from the front-facing camera 304 of the client computing device 114a. Accordingly, in the implementation shown in FIG. 3C, the avatar commentary system 102 can position the bubble 310 containing the video frame feed 316 of the front-facing camera 304 on the digital media feed 306a showing the video frame feed from the rear-facing camera of the client computing device 114a.

As mentioned above, the avatar commentary system 102 can position the user's avatar 308a over other types of digital media feeds. For example, in response to a detected selection of a camera roll button 318 (e.g., shown in FIG. 3C), the avatar commentary system 102 can overlay a camera roll display 320 on the display 302 of the client computing device 114a, as shown in FIG. 3D. In one or more implementations, the avatar commentary system 102 can generate the camera roll display 320 including thumbnails representing digital media (e.g., digital images, digital video) stored locally on the client computing device 114a. In additional implementations, the avatar commentary system 102 can generate the camera roll display 320 including thumbnails representing digital media stored within the social networking system 104 in association with a social networking system account of the user of the client computing device 114a. In yet additional implementations, the avatar commentary system 102 can generate the camera roll display 320 including thumbnails representing digital media stored both on the client computing device 114a and within the social networking system 104, or digital media stored by a third-party system in association with the user of the client computing device 114a.

In response to a detected selection of a digital media item—such as a digital media item 322a shown in FIG. 3D—the avatar commentary system 102 can update the digital media feed 306a. For example, as shown in FIG. 3E, the avatar commentary system 102 can generate an updated digital media feed 306b including the selected digital media item 322a. Moreover, the avatar commentary system 102 can position the user's avatar 308a within the bubble 310 on the updated digital media feed 306b. In one implementation, the updated digital media feed 306b can include an enlarged digital photo. In that implementation, the user of the client computing device 114a may utilize their avatar 308a in commenting on the digital photo. In another implementation, the updated digital media feed 306b can include an enlarged view of a digital video. In that implementation, the user of the client computing device 114a may utilize their avatar 308a in commenting on the digital video as it plays.

In response to another detected selection of the camera roll button 318, the avatar commentary system 102 can again overlay the camera roll display 320 on the display 302 of the client computing device 114a, as shown in FIG. 3F. In response to a detected selection of a second digital media item 322b, the avatar commentary system 102 can generate another updated digital media feed 306c, as shown in FIG. 3G. Additionally, as shown in FIG. 3G, the avatar commentary system 102 can adjust the position of the user's avatar 308a. For example, the avatar commentary system 102 can adjust the position of the user's avatar 308a in response to a detected touch gesture in connection with the bubble 310 that slides the bubble 310 to a different area of the display 302 of the client computing device 114a. In one or more implementations, the avatar commentary system 102 can adjust the position of the user's avatar 308a as many times and as often as the user slides the bubble 310 to a different area within the display 302.

As mentioned above, the avatar commentary system 102 can position a user's avatar over different types of digital media feeds. For example, FIGS. 3A-3G illustrate the avatar commentary system 102 positioning the avatar 308a over digital media feeds including live video frame feeds and stored digital media items. In additional implementations, the avatar commentary system 102 can also position a user's avatar over digital media items within the social networking system 104. For example, the user of the client computing device 114a can access the social networking system 104 via the social networking system application 116. The social networking system 104 can then provide access to digital media items posted/uploaded/created by the user of the client computing device 114a and other social networking system users.

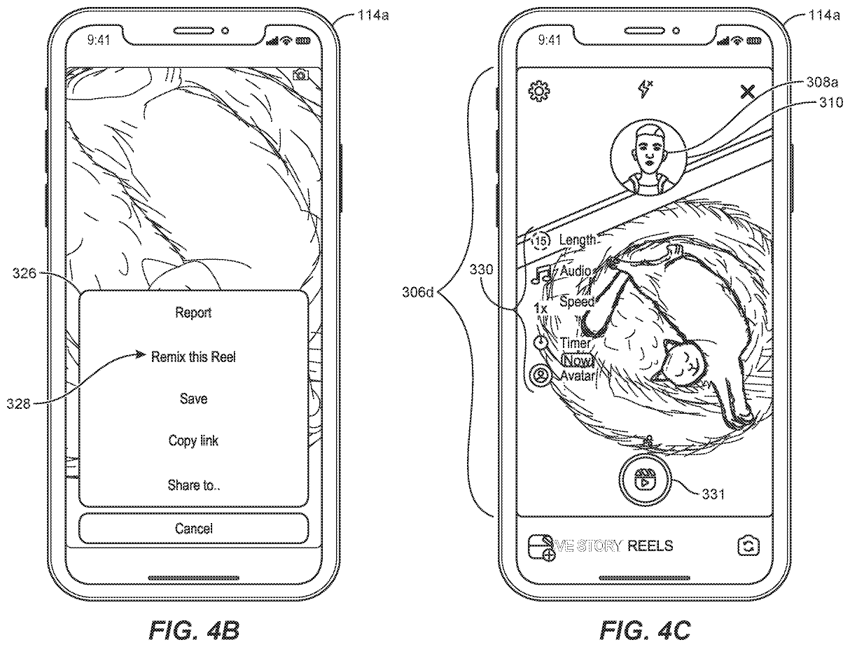

As shown in FIG. 4A, the user of the client computing device 114a can access a digital media feed 306d including a short-form video posted by another social networking system user. For example, the user of the client computing device 114a can access the digital media feed 306d via the social networking system application 116. In one or more implementations, the avatar commentary system 102 can combine the user's avatar with the digital media feed 306d in response to a detected selection of an additional options control 324, followed by a detected selection of a remix option 328 within an options menu 326, as shown in FIG. 4B.

In response to these detected selections, the avatar commentary system 102 can map the user's avatar 308a to the user' expressive gestures, as described above. As shown in FIG. 4C, the avatar commentary system 102 can position the avatar 308a within the bubble 310 onto an area of the digital media feed 306d. As further shown in FIG. 4C, the avatar commentary system 102 can also overlay remix options 330 on the digital media feed 306d in connection with how the avatar commentary system 102 can combine the user's avatar 308a with the digital media feed 306d. For example, the avatar commentary system 102 can adjust or configure audio settings, playback speed settings, avatar settings, etc. in response to detected selections of any of the remix options 330.

In response to a detected selection of a remix button 331, the avatar commentary system 102 can generate a new digital media item including the combination of the user's avatar 308a and the digital media feed 306d. For example, if the digital media feed 306d includes a digital video posted by another user of the social networking system 104, the avatar commentary system 102 can play the digital video in response to the detected selection of the remix button 331. The avatar commentary system 102 can simultaneously record the avatar 308a, which is mapped to the expressive gestures of the user of the client computing device 114a in real-time. As such, the new digital media item generated by the avatar commentary system 102 can include the recording of the user's expressive gestures as shown by the avatar 308a synchronized to the playback of the digital media feed 306d. The avatar commentary system 102 can further broadcast this new digital media item via the social networking system 104. When viewed by other social networking system users, the new digital media item will show how the user of the client computing device 114a reacted to and commented on the digital video shown within the digital media feed 306d.

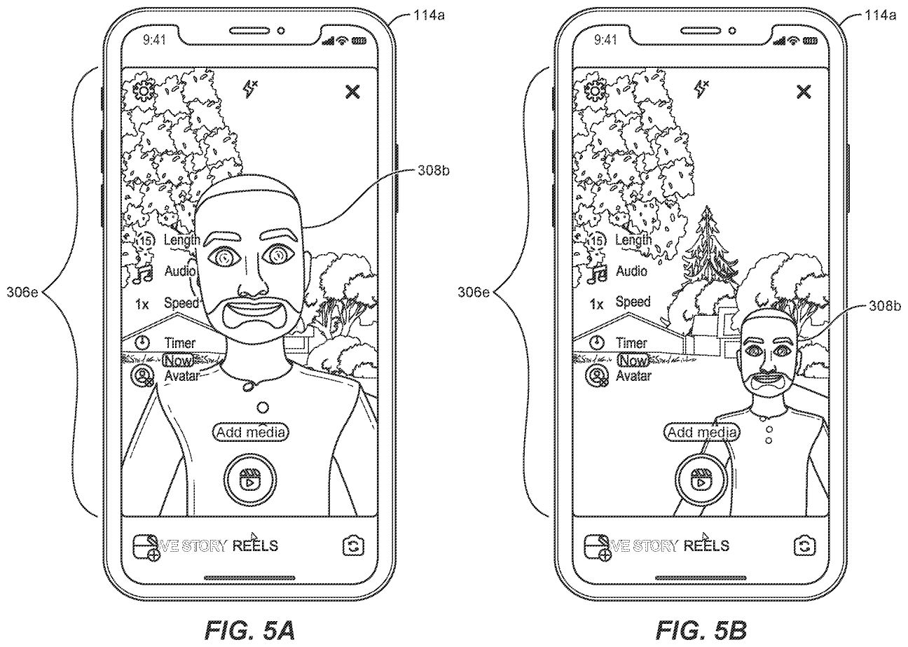

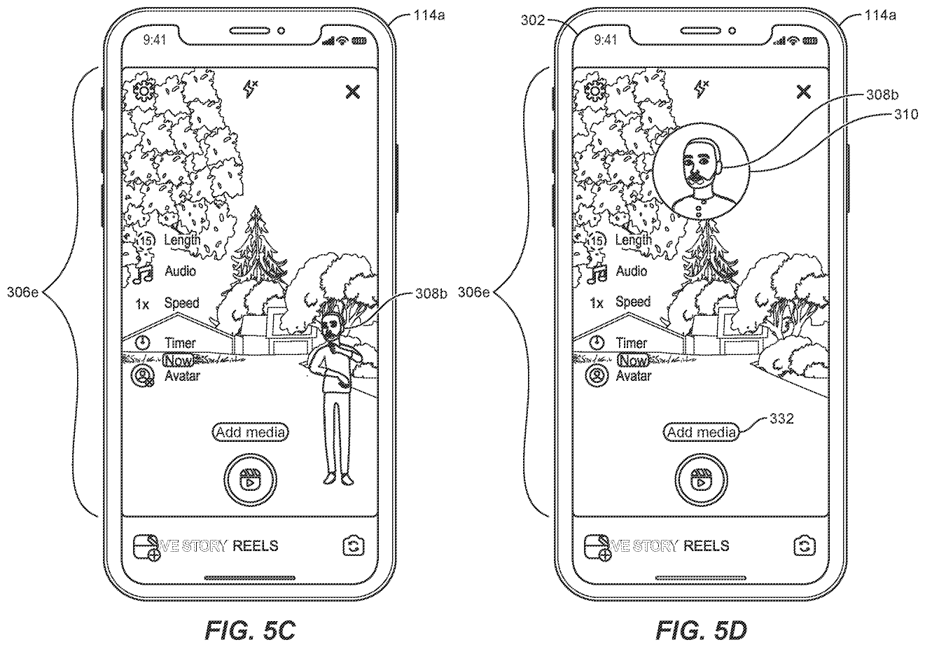

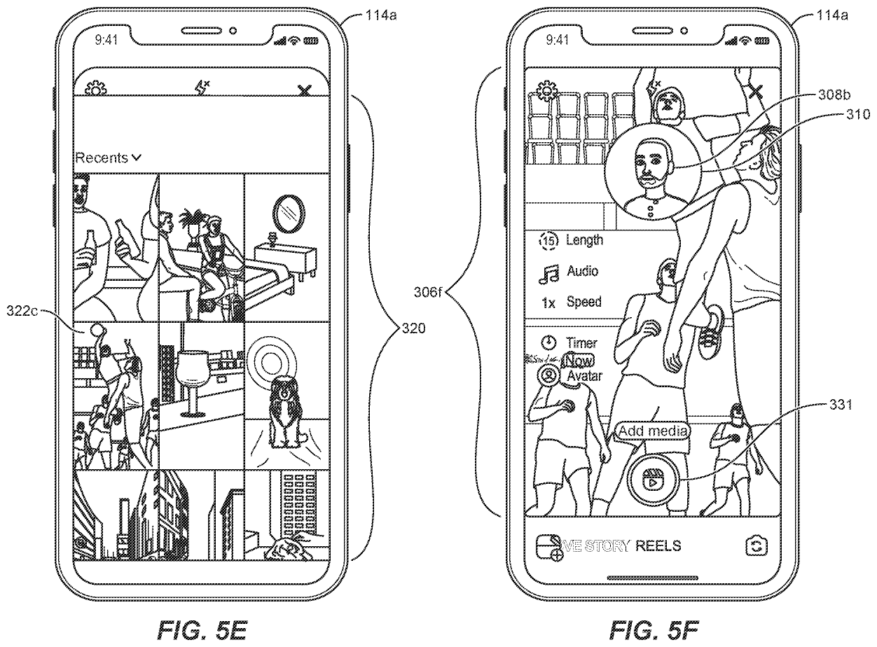

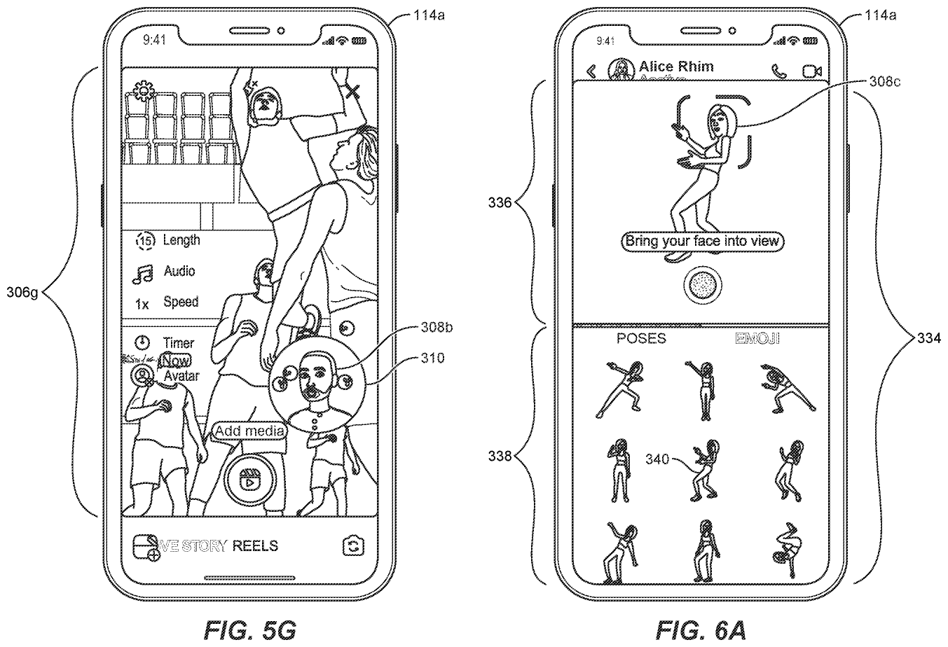

In one or more implementations, as shown throughout FIGS. 3A-4C, the avatar commentary system 102 can position a user's avatar over a digital media feed within the bubble 310. In additional implementations, the avatar commentary system 102 can show and position the user's avatar in other ways. For example, as shown in FIG. 5A, the avatar commentary system 102 can position an avatar 308b in the foreground of the digital media feed 306e. As shown, the avatar commentary system 102 can display the user's avatar 308b in the foreground such that the features of the avatar 308b can be more easily seen and may potentially obscure more of the digital media feed 306e.

In response to detected selections of the avatar 308b, the avatar commentary system 102 can toggle through different views and configurations of the avatar 308b. For example, as shown in FIG. 5B and in response to a detected tap touch gesture in connection with the avatar 308b, the avatar commentary system 102 can modify the avatar 308b to appear farther into the middle distance of the digital media feed 306e. As shown, the avatar commentary system 102 can generate the avatar 308b such that additional features of the avatar 308b (e.g., upper torso, arms) may be seen in connection with the digital media feed 306e.

In response to another detected selection of the avatar 308b, the avatar commentary system 102 can update the avatar 308b by reducing the size of the avatar 308b and moving the avatar 308b farther into the background of the digital media feed 306e, as shown in FIG. 5C. For example, the avatar commentary system 102 can generate the updated avatar 308b to show a full-body view of the avatar 308b. In one or more implementations, the avatar commentary system 102 can map both facial and body features to the user of the client computing device 114a. Moreover, in response to another detected selection of the avatar 308b, the avatar commentary system 102 can update the avatar 308b such that it is displayed within the bubble 310 positioned on the digital media feed 306e. In any of these implementations, the avatar commentary system 102 can reposition the avatar 308b to different locations within the digital media feed 306e in response to detected touch and slide gestures on the display 302 of the client computing device 114a.

As discussed above, the avatar commentary system 102 can generate a new digital media item including the user's avatar 308b combined with the digital media feed 306e. In at least one implementation, the avatar commentary system 102 can enable the addition of multiple digital videos and images while generating the new digital media item. For example, in response to a detected selection of an add media button 332, the avatar commentary system 102 can generate and overlay the camera roll display 320. As discussed above, the avatar commentary system 102 can generate the camera roll display 320 including locally stored digital media items, and digital media items stored within the social networking system 104. In at least one implementation, the avatar commentary system 102 can further generate the camera roll display 320 including digital media items with which the user of the client computing device 114a has engaged via the social networking system 104. To illustrate, the avatar commentary system 102 can generate the camera roll display 320 including digital media items posted by other social networking system users (e.g., digital videos, digital images) that the user of the client computing device 114a has watched, viewed, shared, commented on, liked, etc.

In response to a detected selection of a digital media item 322c within the camera roll display 320, the avatar commentary system 102 can provide the selected digital media item 322c as a digital media feed 306f, as shown in FIG. 5F. In at least one implementation, the avatar commentary system 102 can enable selection of additional digital media items after the remix button 331 has been selected and during creation of the combined digital media item including the avatar 308b and the digital media feed 306f. For example, the avatar commentary system 102 may continue recording during the selection process such that the camera roll display 320 is shown. Alternately, the avatar commentary system 102 can continue recording the previous digital media feed 306e while the selection process is happening, and then switch to the digital media feed 306f following the selection such that the recorded digital media item does not show the camera roll display 320. As discussed above, the avatar commentary system 102 can re-position the avatar 308b during creation of the combined digital media item in response to detected user selections, as shown in FIG. 5G.

As mentioned above in connection with FIG. 5C, the avatar commentary system 102 can generate a full-body display of a user's avatar that is mapped to the user's expressive gestures. In some implementations, the user's expressive gestures may include facial gestures, body gestures, or both. In some implementations, the user may wish to include a full-body display of their avatar where their avatar is mapped to their facial gestures while also expressing different, non-mapped types of body gestures. As such, in one or more implementations, the avatar commentary system 102 can generate the user's avatar such that the avatar's face is mapped to that of the user, while the avatar's body performs other gestures according to a pre-generated animation. Moreover, in some implementations, the avatar commentary system 102 may animate the avatar body based on a computer model (e.g., generative artificial intelligence) that generates avatar animations based on other user inputs such as voice inputs or text inputs.

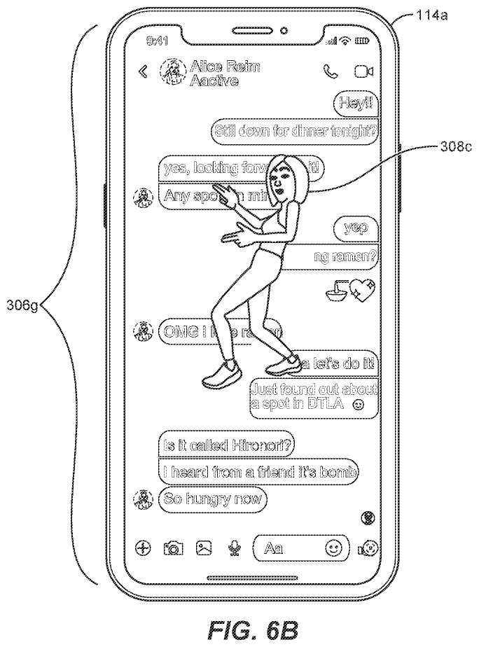

In more detail, FIG. 6A illustrates an avatar configuration panel 334 generated by the avatar commentary system 102. The avatar configuration panel 334 can include a preview window 336 and a pose option window 338. In one or more implementations, the avatar commentary system 102 can include various pre-generated animations in the pose option window 338 that include, for example, different dances, exercises, gymnastic movements, and so forth. In response to a detected selection of a pre-generated animation option 340 in the pose option window 338, the avatar commentary system 102 can map the movement of the corresponding animation to the body features of the avatar 308c in the preview window 336.

Upon configuring the avatar 308c in this manner, the avatar commentary system 102 can display the avatar 308c with the selected animation anywhere the avatar is used within the social networking system 104. For example, as shown in FIG. 6B, the avatar commentary system 102 can position the avatar 308c with the selected animation and otherwise mirroring the face of the user of the client computing device 114a over the digital media feed 306g.

In at least one implementation, the avatar commentary system 102 can provide a hybrid approach that utilizes both tracked user inputs and pre-generated animation. For example, the avatar commentary system 102 can track a user's voice inputs to animate an avatar's mouth (e.g., lip synching). The avatar commentary system 102 can further apply pre-generated animation to the remainder of the avatar's body. In this way, the avatar commentary system 102 can make the user's avatar appear to be speaking the user's words while moving the rest of its body according to the pre-generated animation.

While FIGS. 3A-6B illustrate various features and interfaces generated and provided by the avatar commentary system 102, other variations are possible. For example, although not illustrated, the avatar commentary system 102 can generate avatars and other visual features in different shapes and different colors. Similarly, the avatar commentary system 102 can generate user interfaces and/or overlays with the same or different features in different layouts or arrangements.

As discussed above, the avatar commentary system 102 performs various functions in connection with generating and broadcasting digital media items including combinations of avatars and digital media feeds to comment on the digital media feeds within the social networking system 104. FIG. 7 is a block diagram 700 of the avatar commentary system 102 operating within the social networking system 104 on the server(s) 112. As such, FIG. 7 provides additional detail with regard to these functions. For example, as shown in FIG. 7, the avatar commentary system 102 can include a communication manager 702, an avatar manager 704, and a digital media item manager 706. Additionally, as shown in FIG. 7, the additional elements 108 can include avatar data 708 and digital media item data 710.

In certain implementations, the avatar commentary system 102 may represent one or more software applications or programs that, when executed by a computing device, may cause the computing device to perform one or more tasks. For example, and as will be described in greater detail below, one or more of the communication manager 702, the avatar manager 704, and the digital media item manager 706 of the avatar commentary system 102 may represent software stored and configured to run on one or more computing devices, such as the server(s) 112. One or more of the social networking system status manager 402, the avatar manager 704, and the digital media item manager 706 of the avatar commentary system 102 shown in FIG. 7 may also represent all or portions of one or more special purpose computers to perform one or more tasks.

As mentioned above, and as shown in FIG. 7, the avatar commentary system 102 can include the communication manager 702. In one or more implementations, the communication manager 702 handles tasks associated with sending and receiving data across the network 118. For example, in at least one implementation, the communication manager 702 can receive a video frame feed from any of the client computing devices 114a-114n. As described above, the avatar commentary system 102 can utilize a video frame feed from the client computing device 114a to determine expressive gestures of the user of the client computing device 114a and map those gestures onto an avatar. Accordingly, the communication manager 702 may receive a continuous video frame feed from the client computing device 114a. Additionally, the communication manager 702 may receive select video frames such as every other video frame, every fifth frame, etc. to save network resources and speed the mirroring process.

In one or more implementations, the communication manager 702 can determines social networking system platform being utilized on the client computing device 114a. For example, as mentioned above, the social networking system 104 may include multiple platforms that may be accessed through the same client-side application or through different client-side applications. In at least one implementation, the avatar commentary system 102 can position mirrored avatars over digital media feeds associated with any such platform. Accordingly, the communication manager 702 can determine a specific platform being accessed by the social networking system application 116.

In one or more implementations, the communication manager 702 can generate notifications to other co-users within the determined social networking system platform. For example, in response to the avatar commentary system 102 generating a new digital media item including a user's mirrored avatar reacting to a digital media feed, the communication manager 702 can generate a notification regarding the new digital media item. In some implementations, the avatar commentary system 102 may stream the combination of the user's mirrored avatar and the digital media feed in real-time. In those implementations, the communication manager 702 may generate notifications informing other social networking system users that the live stream will start at a certain time, that the live stream is about to start, that the live stream has started, etc. The communication manager 702 can further provide the notification to co-users within the determined platform. For example, the communication manager 702 can provide the notification regarding the new digital media item to “friends” of the user of the client computing device 114a within the determined platform.

In one or more implementations, the communication manager 702 can broadcast the new digital media item within the determined platform. For example, the communication manager 702 can add the new digital media item to one or more co-user newsfeeds, to one or more co-user's ephemeral content collections, to one or more co-user's short-form video collections and so forth. To do so, the communication manager 702 may confirm access/permission levels associated with co-users prior to broadcasting the new digital media item to those co-users.

As mentioned above, and as shown in FIG. 7, the avatar commentary system 102 can include the avatar manager 704. In one or more implementations, the avatar manager 704 handles tasks associated with generating and maintaining an avatar within the social networking system 104. For example, in response to a detected indication of a user's intention to include a mirrored avatar in a new digital media item (e.g., in response to a detected selection of the remix option 328), the avatar manager 704 can identify an avatar within a social networking system account of the user of the client computing device 114a. For instance, the user's social networking system account can include various avatar configurations that were previously entered by the user to generate an avatar. In at least one implementation, the avatar manager 704 can identify the user's avatar within a social network at a node or position that is connected to the user's social networking system account.

In one or more implementations, the avatar manager 704 can determine representative frames from a video frame feed from a camera of the client computing device 114a for use in mirroring the user's expressive gestures onto the user's avatar. For example, the avatar manager 704 can utilize computer vision techniques to identify frames that are clear (i.e., not blurry), frames where all or most of the user of the client computing device 114a are visible, frames where the user of the client computing device 114a are facing the camera, and so forth. In at least one implementation, the avatar manager 704 may determine that every video frame from the video frame feed is a representative frame. In some implementations, the avatar manager 704 may determine that only some of the video frames from the video frame feed are representative frames.

In one or more implementations, the avatar manager 704 can map a user's expressive gestures onto the user's avatar. For example, the mapping process can include analyzing the representative frames showing the user and adjusting avatar features to mirror the user based on the analysis. In more detail, the avatar manager 704 can analyze a representative frame to determine one or more gesture landmarks depicted within the representative frame. For example, the avatar manager 704 can utilize computer vision techniques to identify facial landmarks (e.g., center points of the eyes, center point of the nose, edge points of the mouth, edge points of the outline of the face), joint landmarks (e.g., center points of the shoulders, neck, elbows, wrists, finger joints), hair landmarks (e.g., points along the user's hairline, edge points of the outline of the user's hair), and body-shape landmarks (e.g., edge points of the user's body against the background within the representative frame).

The avatar manager 704 can further identify relative coordinates for each of the determined gesture landmarks. For example, for a given point of a gesture landmark (e.g., an elbow), the avatar manager 704 can determine pixel coordinates of that point relative to the borders or edges of the representative frame. In this way, the avatar manager 704 can represent the user within the representative frame as a list of point coordinates and their associated type (e.g., nose, elbow, hairline).

In one or more implementations, the avatar manager 704 can mirror the expressive gesture depicted in the representative frame onto the user's avatar by determining avatar landmarks that correspond to the user's gesture landmarks and then adjusting positions of the avatar landmarks based on the user's gesture landmarks. For example, the avatar manager 704 can determine avatar landmarks that correspond to the user's gesture landmarks by using computer vision techniques to label the user's gesture landmarks according to type (e.g., nose, left eye, right shoulder). The avatar manager 704 can then access metadata associated with the user's avatar to identify avatar landmarks with the same labels. Additionally or alternatively, the avatar manager 704 can use the same computer vision techniques to identify the avatar's corresponding landmarks.

The avatar manager 704 can further adjust positions of the avatar landmarks based on the relative coordinates of the user's gesture landmarks. For example, as mentioned above, the avatar manager 704 can determine pixel coordinates of the user's gesture landmarks relative to the edges of the representative frame. In at least one implementation, the avatar manager 704 can further adjust positions of the avatar's corresponding landmarks to be at pixel coordinates that match those of the user's gesture landmarks.

In at least one implementation, the avatar manager 704 can apply pre-generated animations to an avatar. As mentioned above, the avatar commentary system 102 can maintain and offer different pre-generated avatar animations. As such, the avatar manager 704 can apply a pre-generated animation to an avatar by adjusting positions of avatar landmarks in a way prescribed by the animation. For example, the pre-generated animation may include a list of instructions indicating a sequence movement coordinates for avatar landmarks. Accordingly, the avatar manager 704 can adjust the positions of these avatar landmarks based on the coordinates in the sequence. As mentioned above, the avatar manager 704 can animate a portion of the avatar (e.g., the torso, arms, and legs of the avatar) according to a pre-generated animation, while simultaneously mapping the user's face to that of the avatar.

Additionally, the avatar manager 704 can continually update the user's avatar to mirror the user's expressive gestures. For example, as discussed above, the avatar manager 704 can map a user's landmarks to those of the user's avatar according to a representative frame. The avatar manager 704 can repeat that process for every representative frame identified from the user's video frame feed. Thus, when the avatar manager 704 identifies representative frames that are close together, the avatar manager 704 can update the user's avatar such that the avatar appears to mirror the user in real-time.

As mentioned above, and as shown in FIG. 7, the avatar commentary system 102 can include the digital media item manager 706. In one or more implementations, the digital media item manager 706 handles tasks associated with accessing, maintaining, and generating digital media items. For example, the digital media item manager 706 can access digital media items on the client computing device 114a and on the social networking system 104. To illustrate, the digital media item manager 706 can seek permission for and access the camera roll of the client computing device 114a and generate a display (e.g., the camera roll display 320) of digital media items (e.g., most recent digital videos and digital images). Additionally, the digital media item manager 706 can access a camera roll associated with the user of the client computing device 114a within the social networking system 104. Moreover, the digital media item manager 706 can access digital media items posted by other users of the social networking system 104.

In at least one implementation, the digital media item manager 706 can determine permissions associated with digital media items. For example, in at least one implementation, a social networking system user can indicate that a posted digital media item may not be combined with another user's avatar (e.g., may not be “remixed”). The digital media item manager 706 can determine that that digital media item has such a permission setting and prevent that digital media item from being used in connection with other user's avatars.

In one or more implementations, the digital media item manager 706 can generate combined digital media items. For example, the digital media item manager 706 can generate the digital media feed of a selected digital media item on the client computing device 114a. The digital media item manager 706 may further record the user's mirrored avatar during display or playback of the digital media item (e.g., in response to a detected selection of the remix button 331). The digital media item manager 706 may then generate a new digital media item by combining the recording of the avatar synchronized to display or playback of the selected digital media item.

In some implementations, the digital media item manager 706 can generate combined digital media items including a soundtrack. For example, the digital media item manager 706 can record the user's voice (e.g., speaking, singing) via a microphone of the client computing device 114a along with the user's mirrored avatar during display or playback of the digital media item. The digital media item manager 706 can layer the user's voice with any existing audio of the digital media item. Thus, the digital media item manager 706 can generate a combined digital media item that includes the user's voice synchronized to the user's mirrored avatar, which is further synchronized to the digital media feed.

In some implementations, rather than generating a combined digital media item, the digital media item manager 706 can stream the user's mirrored avatar synchronized to the digital media feed. For example, the digital media item manager 706 can synchronize the user's mirrored avatar to the digital media feed in real-time and stream the combination to other co-users within the social networking system 104. In at least one implementation, the digital media item manager 706 may generate a recording of the stream for later playback.

As shown in FIGS. 1 and 7, the server(s) 112 and the client computing devices 114a through 114n can include one or more physical processors, such as the physical processor 110. The physical processor 110 generally represents any type or form of hardware-implemented processing unit capable of interpreting and/or executing computer-readable instructions. In one implementation, the physical processor 110 may access and/or modify one or more of the components of the avatar commentary system 102. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, and/or any other suitable physical processor.

Additionally, the server(s) 112 and the client computing devices 114a-114n can include the memory 106. In one or more implementations, the memory 106 generally represents any type or form of volatile or non-volatile storage device or medium capable of storing data and/or computer-readable instructions. In one example, the memory 106 may store, load, and/or maintain one or more of the components of the avatar commentary system 102. Examples of the memory 106 can include, without limitation, Random Access Memory (RAM), Read Only Memory (ROM), flash memory, Hard Disk Drives (HDDs), Solid-State Drives (SSDs), optical disk drives, caches, variations or combinations of one or more of the same, and/or any other suitable storage memory.

Moreover, as shown in FIG. 7, the server(s) 112 and the client computing devices 114a-114n can include additional elements 108. On the server(s) 112, the additional elements 108 can include the avatar data 708 and the digital media item data 710. In one or more implementations, the avatar data 708 can include avatar appearance configurations, avatar landmark information, avatar feature information, and pre-generated avatar animations. In one or more implementations, the digital media item data 710 can include digital videos and digital images in association with users of the social networking system 104, as well as combined digital media items including avatars mapped to users' expressive gestures while commenting on additional digital media items.

In summary, the avatar commentary system 102 facilitates a new way to comment on and react to digital media items within the social networking system 104. For example, the avatar commentary system 102 can map a user's expressive gestures (e.g., facial expressions, talking, hand gestures, body movements) to the user's avatar in real-time. The avatar commentary system 102 can further position the user's mirrored avatar over a digital media feed of a digital media item (e.g., a camera stream, a digital video during playback, a digital image) such that the user-via their avatar—may comment on the digital media item. The avatar commentary system 102 can generate a new digital media item including the mirrored avatar and the digital media feed that can be broadcast to other social networking system users. As such, the avatar commentary system 102 enables a new commentary medium within the social networking system 104 that is fast and efficient, without the need for additional software applications.

### Example Implementations

Example 1: A computer-implemented method for generating and broadcasting a digital media feed with a positioned avatar can include identifying one or more expressive gestures of a user based on a video frame feed of a client computing device, mapping the one or more expressive gestures of the user onto one or more features of an avatar associated with the user within a social networking system, positioning the avatar over an area of a digital media feed, and broadcasting the digital media feed with the positioned avatar to one or more co-users within the social networking system.

Example 2: The computer-implemented method of claim 1, wherein identifying the one or more expressive gestures of the user includes, for representative frames from the video frame feed, determining one or more gesture landmarks in the representative frame, and identifying relative coordinates for each of the one or more gesture landmarks.

Example 3: The computer-implemented method of any of claims 1 and 2, wherein determining the one or more gesture landmarks in the representative frame includes identifying one or more of facial landmarks, joint landmarks, limb landmarks, hair landmarks, or body-shape landmarks.

Example 4: The computer-implemented method of any of claims 1-3, wherein mapping the one or more expressive gestures of the user to the one or more features of the avatar associated with the user includes, in connection with each frame in the video frame feed, determining one or more avatar landmarks that correspond to the one or more gesture landmarks, and adjusting positions of the one or more avatar landmarks based on the relative coordinates of the one or more gesture landmarks.

Example 5: The computer-implemented method of any of claims 1-4, further including applying one or more pre-generated animation to a body of the avatar, wherein mapping the one or more expressive gestures of the user to the one or more features of the avatar includes mapping one or more facial landmarks of the user to one or more facial landmarks of the avatar while mapping the pre-generated animations to body landmarks of the avatar.

Example 6: The computer-implemented method of any of claims 1-5, wherein positioning the avatar over an area of the digital media feed includes at least one of positioning a face of the avatar over an area of the digital media feed, positioning an upper torso and face of the avatar over an area of the digital media feed, or positioning a body of the avatar over an area of the digital media feed.

Example 7: The computer-implemented method of any of claims 1-6, wherein a digital media feed includes at least one of a front-facing camera video frame feed of the client computing device, a rear-facing camera video frame feed of the client computing device, a digital image from a camera roll associated with the user, or a short-form video available to the user via the social networking system.

Example 8: The computer-implemented method of any of claims 1-7, wherein broadcasting the digital media feed and the positioned avatar to the one or more co-users within the social networking system includes determining a social networking system platform associated with the digital media feed, making the digital media feed with the positioned avatar available via the determined social networking system platform, generating a notification for the digital media feed in association with the user, and providing the notification to the one or more co-users in connection with the social networking system platform.

In some examples, a system may include at least one processor and a physical memory including computer-executable instructions that, when executed by the at least one processor, cause the at least one processor to perform various acts. For example, the computer-executable instructions may cause the at least one processor to perform acts including identifying one or more expressive gestures of a user based on a video frame feed of a client computing device, mapping the one or more expressive gestures of the user onto one or more features of an avatar associated with the user within a social networking system, positioning the avatar over an area of a digital media feed, and broadcasting the digital media feed with the positioned avatar to one or more co-users within the social networking system.

Additionally in some examples, a non-transitory computer-readable medium can include one or more computer-executable instructions that, when executed by at least one processor of a computing device, cause the computing device to perform various acts. For example, the one or more computer-executable instructions may cause the computing device to identify one or more expressive gestures of a user based on a video frame feed of a client computing device, map the one or more expressive gestures of the user onto one or more features of an avatar associated with the user within a social networking system, position the avatar over an area of a digital media feed, and broadcast the digital media feed with the positioned avatar to one or more co-users within the social networking system.

As detailed above, the computing devices and systems described and/or illustrated herein broadly represent any type or form of computing device or system capable of executing computer-readable instructions, such as those contained within the modules described herein. In their most basic configuration, these computing device(s) may each include at least one memory device and at least one physical processor.

In some examples, the term “memory device” generally refers to any type or form of volatile or non-volatile storage device or medium capable of storing data and/or computer-readable instructions. In one example, a memory device may store, load, and/or maintain one or more of the modules described herein. Examples of memory devices include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In some examples, the term “physical processor” generally refers to any type or form of hardware-implemented processing unit capable of interpreting and/or executing computer-readable instructions. In one example, a physical processor may access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the modules described and/or illustrated herein may represent portions of a single module or application. In addition, in certain implementations one or more of these modules may represent one or more software applications or programs that, when executed by a computing device, may cause the computing device to perform one or more tasks. For example, one or more of the modules described and/or illustrated herein may represent modules stored and configured to run on one or more of the computing devices or systems described and/or illustrated herein. One or more of these modules may also represent all or portions of one or more special-purpose computers configured to perform one or more tasks.

In addition, one or more of the modules described herein may transform data, physical devices, and/or representations of physical devices from one form to another. Additionally or alternatively, one or more of the modules recited herein may transform a processor, volatile memory, non-volatile memory, and/or any other portion of a physical computing device from one form to another by executing on the computing device, storing data on the computing device, and/or otherwise interacting with the computing device.

In some implementations, the term “computer-readable medium” generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary implementations disclosed herein. This exemplary description is not intended to be exhaustive or to be limited to any precise form disclosed. Many modifications and variations are possible without departing from the spirit and scope of the present disclosure. The implementations disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A computer-implemented method comprising:
identifying one or more expressive gestures of a user based on a video frame feed of a client computing device;
mapping the one or more expressive gestures of the user onto one or more features of an avatar associated with the user within a social networking system;
positioning the avatar over an area of a digital media feed; and
broadcasting the digital media feed with the positioned avatar to one or more co-users within the social networking system.

2. The computer-implemented method of claim 1, wherein identifying the one or more expressive gestures of the user comprises, for representative frames from the video frame feed:
determining one or more gesture landmarks in the representative frame; and
identifying relative coordinates for each of the one or more gesture landmarks.

3. The computer-implemented method of claim 2, wherein determining the one or more gesture landmarks in the representative frame comprises identifying one or more of facial landmarks, joint landmarks, limb landmarks, hair landmarks, or body-shape landmarks.

4. The computer-implemented method of claim 2, wherein mapping the one or more expressive gestures of the user to the one or more features of the avatar associated with the user comprises, in connection with each frame in the video frame feed:
determining one or more avatar landmarks that correspond to the one or more gesture landmarks; and
adjusting positions of the one or more avatar landmarks based on the relative coordinates of the one or more gesture landmarks.

5. The computer-implemented method of claim 4, further comprising applying one or more pre-generated animations to a body of the avatar,
wherein mapping the one or more expressive gestures of the user to the one or more features of the avatar comprises mapping one or more facial landmarks of the user to one or more facial landmarks of the avatar while mapping the pre-generated animations to body landmarks of the avatar.

6. The computer-implemented method of claim 1, wherein positioning the avatar over an area of the digital media feed comprises at least one of: positioning a face of the avatar over an area of the digital media feed, positioning an upper torso and face of the avatar over an area of the digital media feed, or positioning a body of the avatar over an area of the digital media feed.

7. The computer-implemented method of claim 1, wherein a digital media feed comprises at least one of a front-facing camera video frame feed of the client computing device, a rear-facing camera video frame feed of the client computing device, a digital image from a camera roll associated with the user, or a short-form video available to the user via the social networking system.

8. The computer-implemented method of claim 1, wherein broadcasting the digital media feed and the positioned avatar to the one or more co-users within the social networking system comprises:
determining a social networking system platform associated with the digital media feed;
making the digital media feed with the positioned avatar available via the determined social networking system platform;
generating a notification for the digital media feed in association with the user; and
providing the notification to the one or more co-users in connection with the social networking system platform.

9. A system comprising:
at least one physical processor; and
physical memory comprising computer-executable instructions that, when executed by the at least one physical processor, cause the at least one physical processor to perform acts comprising:
identifying one or more expressive gestures of a user based on a video frame feed of a client computing device;
mapping the one or more expressive gestures of the user onto one or more features of an avatar associated with the user within a social networking system;
positioning the avatar over an area of a digital media feed; and
broadcasting the digital media feed with the positioned avatar to one or more co-users within the social networking system.

10. The system of claim 9, wherein identifying the one or more expressive gestures of the user comprises, for each frame in the video frame feed:
determining one or more gesture landmarks in representative frame; and
identifying relative coordinates for each of the one or more gesture landmarks.

11. The system of claim 10, wherein determining the one or more gesture landmarks in the representative frame comprises identifying one or more of facial landmarks, joint landmarks, limb landmarks, hair landmarks, or body-shape landmarks.

12. The system of claim 10, wherein mapping the one or more expressive gestures of the user to the one or more features of the avatar associated with the user comprises, in connection with each frame in the video frame feed:
determining one or more avatar landmarks that correspond to the one or more gesture landmarks; and
adjusting positions of the one or more avatar landmarks based on the relative coordinates of the one or more gesture landmarks.

13. The system of claim 12, further comprising computer-executable instructions that, when executed by the at least one physical processor, cause the at least one physical processor to perform an act comprising applying one or more pre-generated animations to a body of the avatar,
wherein mapping the one or more expressive gestures of the user to the one or more features of the avatar comprises mapping one or more facial landmarks of the user to one or more facial landmarks of the avatar while mapping the pre-generated animations to body landmarks of the avatar.

14. The system of claim 9, wherein positioning the avatar over an area of the digital media feed comprises at least one of: positioning a face of the avatar over an area of the digital media feed, positioning an upper torso and face of the avatar over an area of the digital media feed, or positioning a body of the avatar over an area of the digital media feed.

15. The system of claim 9, wherein a digital media feed comprises at least one of a front-facing camera video frame feed of the client computing device, a rear-facing camera video frame feed of the client computing device, a digital image from a camera roll associated with the user, or a short-form video available to the user via the social networking system.

16. The system of claim 9, wherein broadcasting the digital media feed and the positioned avatar to the one or more co-users within the social networking system comprises:
determining a social networking system platform associated with the digital media feed;
making the digital media feed with the positioned avatar available via the determined social networking system platform;
generating a notification for the digital media feed in association with the user; and
providing the notification to the one or more co-users in connection with the social networking system platform.

17. A non-transitory computer-readable medium comprising one or more computer-executable instructions that, when executed by at least one processor of a computing device, cause the computing device to:
identify one or more expressive gestures of a user based on a video frame feed of a client computing device;
map the one or more expressive gestures of the user onto one or more features of an avatar associated with the user within a social networking system;
position the avatar over an area of a digital media feed; and
broadcast the digital media feed with the positioned avatar to one or more co-users within the social networking system.

18. The non-transitory computer-readable medium of claim 17, further comprising one or more computer-executable instructions that, when executed by the at least one processor of the computing device, cause the computing device to identify the one or more expressive gestures of the user by, for each frame in the video frame feed:
determining one or more gesture landmarks in representative frame; and
identifying relative coordinates for each of the one or more gesture landmarks.

19. The non-transitory computer-readable medium of claim 18, wherein determining the one or more gesture landmarks in the representative frame comprises identifying one or more of facial landmarks, joint landmarks, limb landmarks, hair landmarks, or body-shape landmarks.

20. The non-transitory computer-readable medium of claim 18, further comprising one or more computer-executable instructions that, when executed by the at least one processor of the computing device, cause the computing device to map the one or more expressive gestures of the user to the one or more features of the avatar associated with the user by, in connection with each frame in the video frame feed:
determining one or more avatar landmarks that correspond to the one or more gesture landmarks; and
adjusting positions of the one or more avatar landmarks based on the relative coordinates of the one or more gesture landmarks.
